(19) United States
(12) Patent Application Publication
(10) Pub. No.: US 2015/0100371 A1
(43) Pub. Date: Apr. 9, 2015

(54) Detecting Closure of a Business

(71) Applicant: Google Inc., (US)

(72) Inventor: Adam Leader, Scarsdale, NY (US)

(21) Appl. No.: 13/856,145

(22) Filed: Apr. 3, 2013

(51) Int. Cl. G06Q 30/02

(52) U.S. Cl. CPC G06Q 30/0201
USPC 705/7.29

(57) ABSTRACT

Provided is a process of updating a listing of businesses by detecting that a business has closed, the process including: obtaining interaction time-series data identifying when users interacted with data about a business; calculating a baseline rate of user interactions with the data about the businesses based on the interaction time-series data; detecting a decrease in the rate of user interactions with the data about the business based on baseline rate and the interaction time series data in response to the detected decrease, transmitting a message to the business requesting confirmation that the business is still open; and detecting that a time has passed without the requested confirmation and, in response, removing the business from a business listing or otherwise indicating in the listing that the business is dosed.

### BACKGROUND OF THE INVENTION

1. Field of the Invention

The present invention relates generally to electronic records, and more specifically, to business listings.

2. Description of the Related Art

Business listings are used in a variety of contexts. Web-based maps often display businesses identified in such listings, and local search engines often include business listings when responding to a query. For example, a user interested in restaurants will often query a search engine for restaurants near some area, and the search engine will identify restaurants meeting the user's criteria based on records in a business listing for restaurants. Because users often take action based on the data identified by the business listing, e.g., driving to a store or restaurant, an inaccurate attribute of a business listing can be a had user experience (for example, omitting a business that would have better net the users needs; or listing a business that is currently closed as open, leading a user astray if they attempt to call or visit the establishment).

Maintaining accurate business listings using humans is relatively expensive versus automated techniques. The more geographies and the more categories of places, the greater the benefit of partial or full automation. Business churn (lifecycle changes) are inevitable and the operator of a business has weak incentives to alert those who maintain business listings when a business closes. Having a person contact every business listing to verify the details is prohibitively expensive. Businesses close often enough that it would be helpful to more quickly detect closure of the business and verify the correctness of the business listing, so as to reduce the likelihood of inconveniencing a user drawing information from the business listing.

### SUMMARY

The following is a non-exhaustive listing of some aspects of the present techniques. These and other aspects are described in the following disclosure.

Some aspects include a process of updating a listing of businesses by detecting that a business has closed, the process including: obtaining interaction time-series data identifying when users interacted with data about a business; calculating a baseline rate of user interactions with the data about the businesses based on the interaction time-series data; detecting, with a computer, a decrease in the rate of user interactions with the data about the business based on baseline rate and the interaction time-series data; in response to the detected decrease, transmitting a message to the business requesting confirmation that the business is still open; and detecting that a time has passed without the requested confirmation and, in response, updating the existence status of the business listing to reflect that the business is temporarily or permanently closed.

Some aspects include a tangible, non-transitory, machine-readable medium storing instructions that when executed by a data processing apparatus cause the data processing apparatus to perform operations comprising: obtaining interaction time-series data identifying when users interacted with data about a business; calculating a baseline rate of user interactions with the data about the businesses based on the interaction time-series data; detecting, with a computer, a decrease in the rate of user interactions with the data about the business based on baseline rate and the interaction time-series data; in response to the detected decrease, transmitting a message to the business requesting confirmation that the business is still open; and detecting that a time has passed without the requested confirmation and, in response, updating the existence status of the business listing to reflect that the business is temporarily or permanently closed.

Some aspects include a system having one or more processors and memory storing instructions that when executed by the one or more processors cause operations comprising: obtaining interaction time-series data identifying when users interacted with data about a business; calculating a baseline rate of user interactions with the data about the businesses based on the interaction time-series data; detecting a decrease in the rate of user interactions with the data about the business based on baseline rate and the interaction time-series data; in response to the detected decrease, transmitting a message to the business requesting confirmation that the business is still open; and detecting that a time has passed without the requested confirmation and, in response, removing the business from a business listing or otherwise indicating that the business is closed.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 is a block diagram of a computing environment having an embodiment of a business-closure sensor;

FIG. 2 is a flow chart of an embodiment of a process for updating a business listing;

FIG. 3 is a graph of an example of interaction data indicating closure of a business; and

FIG. 4 is a diagram that illustrates an exemplary computing system.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF CERTAIN EMBODIMENTS

In some embodiments, a business-closure sensor monitors trends in user interactions that implicate business listings. Decreases in interactions identifying a given business prompt an automated call/email to the business owner. Unless the owner confirms the business is open, it is removed from the business listing.

The business-closure sensor, in some embodiments, receives as input interaction data. The interaction data comes from user interactions with systems that pull data from the business listing. Examples of the interactions include user reviews of businesses on websites, ratings of businesses, check-ins to businesses, and edits to webpages by business owners. The interactions produce interaction data that is stored in a form that 1) identifies a business, and 2) indicates when the interaction occurred. Thus, inputs to the business-closure sensor include the interaction data and the business listings to be verified.

In some embodiments, the business-closure sensor periodically analyzes this interaction data to detect decreases in the rate of interactions for listed businesses. To this end, certain versions of the business-closure sensor calculate a baseline rate of user interaction relating to a business by, for example, summing the various types of interactions and calculating a moving average of user interaction rates over time. Deviations from the moving average, e.g., decreases by more than a threshold amount, are detected by the business-closure sensor, thereby indicating that the business may have closed. Some embodiments improve accuracy by accounting for periodic (e.g., weekly, monthly, or seasonal) variations in interactions and by accounting for uncertainty arising from the sample size and the variability of interaction data. Accounting for these factors may include normalizing the moving average or adjusting the threshold.

If a decrease of sufficient magnitude is detected for a given business, in some embodiments, the owner of the business is automatically contacted (e.g., via an automated call, an email, chat, etc.) by the business-closure sensor, and the owner is presented with an interface by which the owner can confirm the business is still open. Absent confirmation, the business is either deleted from the listing of businesses or, in some embodiments, added to a queue for a human to confirm closure, thereby yielding a revised listing of businesses.

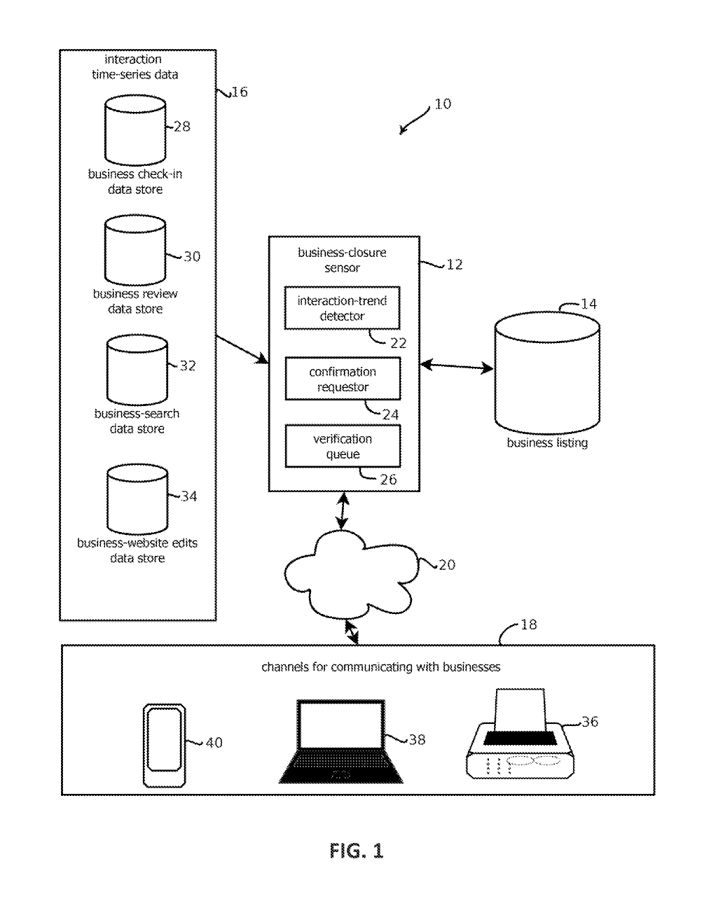

FIG. 1 shows an example of a computing environment 10 having an embodiment of a business-closure sensor 12. The illustrated business-closure sensor 12 is capable of exchanging data with a business listing 14, sources of interaction time-series data 16, and various channels for communicating with businesses 18 via a network 20, such as the Internet, the mail, or the public switched telephone network.

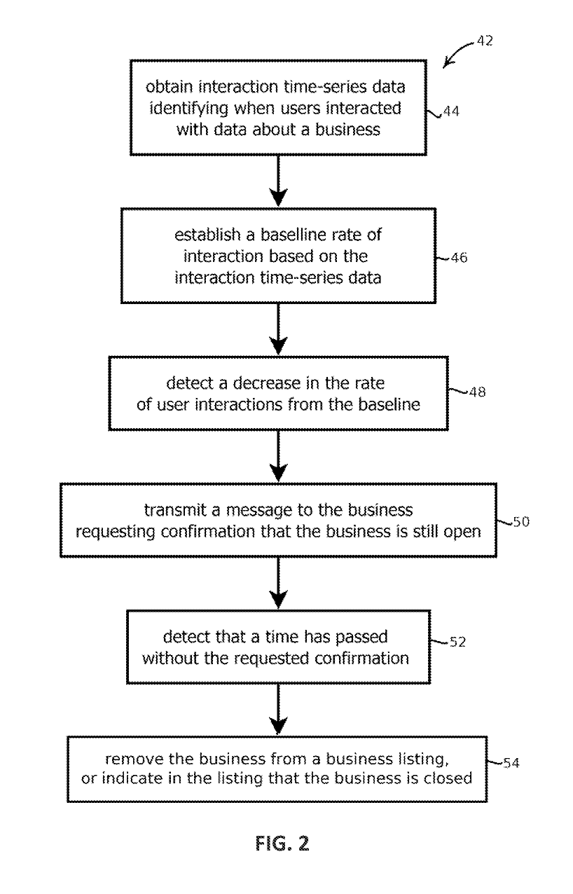

In some embodiments, the business-closure sensor 12 includes an interaction-trend detector 22, a confirmation requester 24, and a verification queue 26. These components 22, 24, and 26 may execute a process described below with reference to FIG. 2 for updating a business listing. Generally, the illustrated interaction-trend detector 22 retrieves interaction time-series data from source 16, establishes a baseline rate of user interaction with data about a business, and detects downward deviations in the rate of user interaction. In response to detecting a downward deviation, the interaction-trend detector 22 signals the confirmation requester 24, which then composes and transmits an interface for a business owner/manager to confirm that the business is still open. The interface may be an e-mail, a text message, a post card, or a telephone message transmitted via the network 20 and one of the channels 18 and inviting a person associated with the business to confirm that the business is still open. The confirmation requester 24 may receive the confirmation or detect the absence of such confirmation after some duration. Absent confirmation, the confirmation requester 24 places the business listing in the verification queue 26 for a person or other verification system to verify that the business is in fact closed. In response to receiving such verification, the verification queue module 26 then removes the business listing from the business listing repository 14. Or in some embodiments, the confirmation requester 24 removes the business from the business listing 14 without waiting for a response from the verification queue module 26, e.g., if the downward deviation in user interaction exceeds a second, more stringent threshold.

These modules, 22, 24, and 26, and other components of the business-closure sensor 12 may be embodied as hardware (e.g., one or more properly programmed processors coupled to one or more memory devices) or software stored on a tangible non-transitory machine-readable medium and executed by one or more processors to effectuate the functionality described herein. Further, the components 22, 24, and 26 are illustrated as discrete modules, but in some embodiments, the code or hardware embodying these modules 22, 24, and 26 may be intermingled, dispersed, co-located, integrated, distributed, or otherwise differently organized.

The business listing repository 14, in some embodiments, includes a plurality of records each about a business. Each record may include information such as a canonical business name, alternate business names, a business identifier key value, and contact information for the confirmation requester 24 to contact a person associated with the business, e.g., an e-mail address, a phone number, or a mailing address. The record may also categorize the business (e.g., restaurants, retail stores, doctor's offices) in a single-level or hierarchical taxonomy and identify groups of related businesses, e.g., franchises. The business listing repository 14 is coupled to, or mirrored by, systems that provide information about businesses, for example geographic information systems (e.g., associated with interactive web-based maps), local business listings in which users rate businesses, search engines, and social networks having information about businesses, such as services by which users register their presence in the business by “checking in” to the business.

In some embodiments, some of the same services that draw data from the business listing 14 provide data to the interaction time-series data sources 16. Examples of interaction-time-series data come from a business check-in data store 28, a business-review data store 30, a business-search data store 32, and a business-website edits data store 34. Each of these data stores 28, 30, 32, and 34 store interaction time-series data, which includes a plurality of records each identifying a business and when a user interacted with data associated with that business. For example, when a user checked into a given business, when a user posted a review of a given business, when a user searched a web search engine for information related to a business, or when a user edited a website of a business.

In some embodiments, the business-closure sensor 12 communicates with business operators through the channels 18 in order to confirm whether a business is closed. Such communication may occur by causing a printer 36 to print a postcard or other document addressed to the business operator and requesting return of the document to confirm the business is still open. Or the communication may occur via e-mail or instant messenger, in a communication to a laptop 38 or a smart phone 40. In some embodiments, the indication may include a telephone call to the phone number listed in the business listing, for example via text-to-voice synthesis or recorded audio and voice recognition or touchtone recognition systems by which a message is read to an operator of the business and by which the operator's response is registered.

In some embodiments, the business-closure sensor 12 of FIG. 1 executes a process 42 illustrated by FIG. 2. The process 42 updates a business listing by detecting decreases in the rate of user action with data about businesses and, in response, removing businesses that have likely closed from the business listing. The process 42 may be executed by the business-closure sensor 12 (or other system) periodically, for example daily. Further, the process 42 may be repeated for each business in the business listing, for example by iterating through the businesses in the business listing or mapping the process to the listing and evaluating one business at a time per iteration or mapped instance. To this end, the process 42, in some embodiments, begins with obtaining a business identifier from a business listing, the business identifier indicating which business is being evaluated and being associated with contact information for the business.

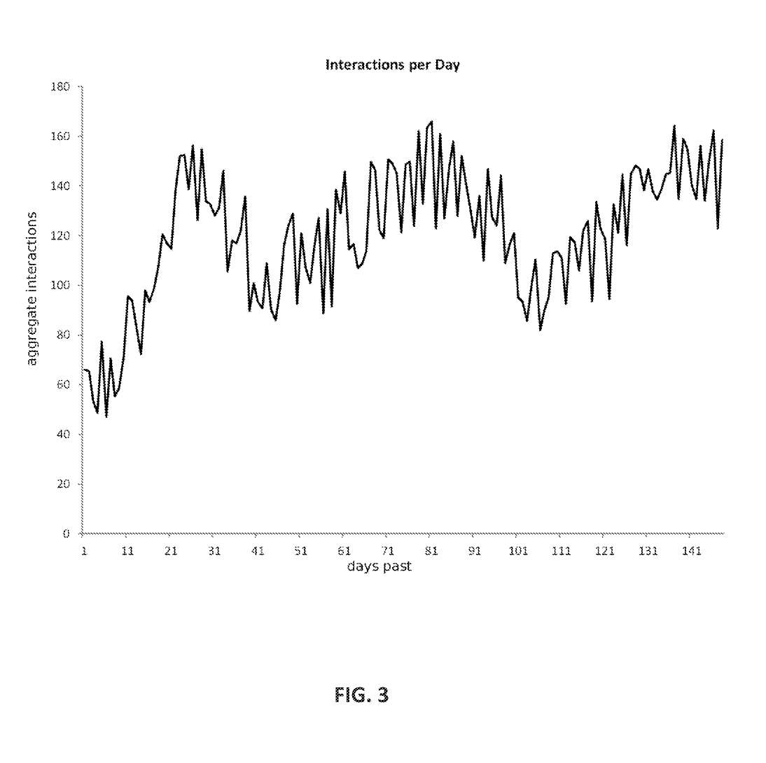

In the illustrated example, the process 42 includes obtaining interaction time-series data identifying when users interacted with data about a business, as illustrated by block 44. This data is obtained from the interaction time-series data sources 16 by the interaction-trend detector 22 (FIG. 1). Interaction time-series data is depicted by way of example in FIG. 3, in which days in the past is mapped to the abscissa and the total number of interactions occurring on that day is mapped to the ordinate. In this example, the interaction rate can be determined as the number of interactions per day. More generally, the rates can be determined at different time scales, for example, as the number of interactions per hour, per week, per month or per year. As illustrated. in FIG. 3, the daily interaction rate has dropped within the previous 20 days, potentially indicating that a business has closed. However, the example also illustrates stochastic components of interaction rates that reduce the probative value of smaller data sets and smaller deviations for identifying business closures. Similarly, the example illustrates periodic components in interaction rates, e.g., seasonal trends, that may interfere, in some cases, with efforts to detect persistent, real decreases in interaction rates.

Next, in some embodiments, the interaction-trend detector 22 establishes a baseline rate of interaction based on the interaction time-series data, as indicated by block 46. The baseline rate may be calculated in any of a variety of ways. For example, the baseline rate may be determined by calculating a moving average of the total number of user interactions during a trailing duration, such as the number of interactions in the previous seven days. The trailing duration is selected with an eye towards trade-offs between the responsiveness of the business closure sensor 12 and the risk of false positives, with a shorter trailing duration tending to make the sensor 12 more responsive while increasing the risk of false positives. The trailing duration may be less than, equal to, or greater than one day, one week, one month, or one quarter, for example, depending on these trade-offs.

In some embodiments, different types of user interaction may be weighted differently when calculating the rate of interaction. For example, edits to the businesses website may be weighted more heavily than web searches for information about the business because, in some cases, users are more likely to continue searching for information about a business after it has closed than business owners are to continue editing the website of a business after it has closed. Similarly, in some cases, check-ins may be weighted more heavily than business reviews, which may be weighted more heavily than web searches to account for differing strengths of correlation with the closure of a business. The weighted counts may be summed over a trailing duration to calculate a weighted rate of user interaction. The weightings may be adjusted based on feedback. In some embodiments, false positives and false negatives of business closures identified by the interaction-trend detector 22 are recorded, for instance based on user complaints about errors in the business listing or errors detected in the verification queue 26, and these recorded errors are used to adjust the weightings applied to different types of user interactions. As used herein, a false positive is an identification by the interaction-trend detector 22 that a business has closed, when in fact the business is currently open. Similarly, a false negative is an identification by the interaction-trend detector 22 that a business is currently open, when in fact the business has closed.

The process 42 of the present embodiment further includes detecting a decrease in the rate of user actions from the baseline, as indicated by block number 48. Detecting the decrease may be performed by the above-mentioned interaction-trend detector 22 of FIG. 1. A variety of techniques may be used to detect the decrease, the choice of which will again depend on trade-offs between accuracy and sensitivity. For example, some embodiments detect a decrease when the interaction rate drops below a threshold. The threshold may be selected based on statistics of the data by which the baseline rate of user action is established. For example, the threshold may be selected based on variability of the data, such as three, four, or more standard deviations below the baseline rate. In another example, the threshold is expressed as some percentage decrease from the baseline rate. Some embodiments apply a threshold to a first or second order derivative of the rate of user interaction to detect trends or changes in trends, as an consistent or accelerating downward trend in user interactions may indicate closure more quickly than the rate of interactions, and some embodiments combine the rate of interaction, the first order derivative, and the second order derivative to calculate an aggregate score to be compared against a threshold.

In some embodiments, the steps 46 or 48 account for uncertainty arising from the interaction time-series data. For example, a relatively small data set may exhibit greater uncertainty than a relatively large data set. To this end, the threshold may be modulated based on the sample size, with a smaller sample size tending to lower the threshold to reduce the risk of false positives.

Sonic embodiments adjust the threshold in the detection step 48 based on a specified risks of false positives and false negatives. These embodiments, in some cases, match the time-series data to one of various candidate probability distributions, such as a Gaussian distribution, a log-normal distribution, or a power law distribution, by selecting a distribution that exhibits a closer fit to the data than other candidate distributions. This can be done, for instance, by adjusting candidate distribution parameters to fit the data, summing the errors between the fitted candidate distributions and the actual data, and then selecting a fitted candidate distribution with the lowest total error among the candidate distributions. The threshold then is calculated based on the sample size, a maximum acceptable likelihood of a false positive, a maximum acceptable likelihood of a false negative, and the estimated parameters of the selected distribution, for example the mean and standard deviation of a normal distribution. In some cases, closures are detected with a Bayesian classifier.

In some embodiments, the steps 46 or 48 account for periodic components of the rate of interaction, such as weekly, monthly, seasonal, or yearly trends. For example, a store specializing in Christmas decorations is expected to exhibit user interactions that cycle yearly, and in this case, a decrease in user interactions following Christmas would not necessarily indicate that the store has closed. Such periodic effects may be detected and characterized with techniques for harmonic analysis of stochastic processes. Accounting for periodic components may be performed on the different types of user interaction data before aggregating the different types of user interaction data in order to detect periodic components more clearly. For example, businesses that are closed on weekends may be more detectable via check-in data rather than web search data, since users may continue to search for information about such businesses over the weekend even though the businesses are closed, but are not likely to check-into such businesses over the weekend. Periodic weightings may be determined for such periodic effects in the business interaction data, and applied before establishing the baseline rate or detecting a decrease in the baseline rate of business interactions. The periodic weightings may be determined based on the amplitude and phase of the detected periodic effect. Alternatively or additionally, the threshold at which decreases in the business interaction data are detected can be modulated to account for such periodic components in the business interaction data, for example, by lowering the threshold at periodic minima and raising the threshold at periodic maxima.

The various techniques described above for establishing the baseline rate of interaction and detecting a decrease in that rate, or for performing other forms of trend analysis, may be combined in different permutations defined by the above set of techniques. Further, parameters of each of the techniques may be dynamically adjusted based on feedback indicating fake positives or false negatives.

Next in some embodiments of process 42, in response to detecting a decrease in the rate of user interactions from the baseline, a message is transmitted to the business requesting confirmation that the business is still open, as indicated by block 50. The confirmation message may be automatically generated, for example by the confirmation requestor 24 (FIG. 1), with a variety of techniques. For example, a voice synthesizer or recorded audio may convey an audible message to a person associated with the business. In other examples, an e-mail is automatically composed and e-mailed to such a person, a text message is composed and sent, a fax is composed and sent, etc.

In some embodiments, the process 42 includes detecting that a duration of time has passed without receiving the requested confirmation, as indicated by block 52. This step may be performed by the above-mentioned confirmation requestor 24 (FIG. 1). The confirmation requestor 24 is configured to receive a response by the person associated with the business, for example through voice recognition software, detecting touch tones from a telephone, by scanning a postcard or other paper form returned by the person, or by detecting an e-mail, text message, instant message, or other electronic indication returned from an address to which a confirmation request was sent.

The amount of time that passes without confirmation in step 52 is selected based on a variety of factors. In some embodiments, the amount of time is selected based on the type of message sent in step 50, for example the amount of time may be shorter for e-mails, such as one week, and longer for mailed messages, such as one month. In another example, the amount of time may be selected based on the type of business, for example certain categories of business are expected to be more responsive.

In response to detecting that the amount of time has past, the process 42 of this embodiment proceeds to remove the business from a business listing, which can include indicating in the listing that the business is closed, as indicated by step 54. Noting in the listing that the business is dosed, rather than deleting the record entirely, provides a historical record of the business that can be used to indicate to users both that the business did in fact exist, giving the user confidence in the search process by showing businesses with which the user might be familiar, while also indicating that the business is now closed. Removing the business is expected to yield a more accurate business listing without incurring the cost of a human being visiting the business to confirm closure or waiting for a user to be inconvenienced by an inaccurate record in the business listing. In some embodiments, prior to removing the business from the business listing, the business may be added to the above-mentioned verification queue 26 of FIG. 1, and a person or secondary verification system may attempt to contact the business owner to confirm closure before removing the listing. In this case, the process 42 is expected to reduce the number of entries unnecessarily listed in the verification queue relative to systems that require every business pass through a verification queue.

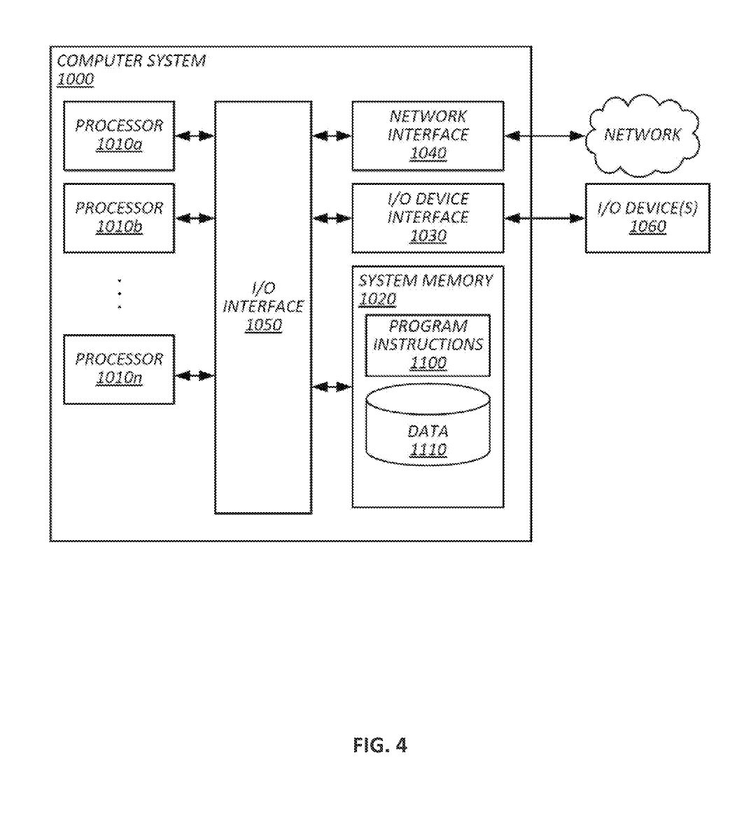

FIG. 4 is a diagram that illustrates an exemplary computing system 1000 in accordance with embodiments of the present technique. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030 and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described. herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area (WAN), a cellular communications network or the like.

System memory 1020 may be configured to store program instructions 1100 or data. 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include, non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). In some embodiments, the program may be conveyed by a propagated signal, such as a carrier wave or digital signal conveying a stream of packets.

I/O interface 1050 may be configured to coordinate I/O traffic between processors 1010a-1010n, system memory 1020, network interface 1040, I/O devices 1060 and/or other peripheral devices. I/O interface 1050 may perform protocol, timing or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000, or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending or storing instructions or data implemented in accordance with the foregoing description upon a computer-accessible medium. Accordingly, the present invention may be practiced with other computer system configurations.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a”, “an” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, encompassing both “and” and “or.” Terms relating to causal relationships, e.g., “in response to,” “upon,” “when,” and the like, encompass causal relationships having both causes that are a necessary causal condition and causes that are a sufficient causal condition, e.g., “state X occurs upon condition Y obtaining” is generic to “X occurs solely upon Y” and “X occurs upon Y and Z.” Similarly, unless otherwise indicated, statements that one value or action is “based on” another condition or value encompass both instances in which the condition or value is the sole factor and instances in which the condition or value is one factor among a plurality of factors. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic processing/computing device. In the context of this specification, a special purpose computer or a similar special purpose electronic (processing or computing device is capable of manipulating or transforming signals, for instance signals represented as physical electronic, optical, or magnetic quantities within memories, registers, or other information storage devices, transmission devices, or display devices of the special purpose computer or similar special purpose processing or computing device.

What is claimed is:

1. A method of updating a listing of businesses by detecting that a business has closed, the method comprising:
obtaining interaction time-series data identifying when users interacted with data about a business;
calculating a baseline rate of user interactions with the data about the businesses based on the interaction time-series data;
detecting, with a computer, a decrease in the rate of user interactions with the data about the business based on the baseline rate and the interaction time-series data;
transmitting a message to the business requesting confirmation that the business is still open;
detecting that a time has passed without receiving the requested confirmation; and
removing the business from a business listing or otherwise indicating in the listing that the business is closed.

2. The method of claim 1, wherein detecting a decrease in the rate of user interactions comprises:
calculating a moving average of the time-series data; and
detecting that the moving average has dropped below a threshold.

3. The method of claim 2, wherein the threshold is based on the baseline rate of user interactions.

4. The method of claim 2, further comprising:
identifying a cyclical component in the user interaction time-series data having a magnitude and a phase; and
adjusting the user interaction data, the baseline rate, or the threshold based on the magnitude and phase of the cyclical component prior to detecting the decrease in the rate of user interactions.

5. The method of claim 1, wherein removing the business from a business listing or otherwise indicating in the listing that the business is closed further comprises:
adding the business to a list of businesses to be investigated; and
receiving confirmation after an investigation that the business is to be removed from the business listing or is to be listed as closed.

6. The method of claim 1, further comprising applying a low-pass filter to the interaction time-series data prior to detecting a decrease in a rate of user interactions.

7. The method of claim 1, comprising:
identifying a periodic component of the time-series data; and
normalizing the time-series data or a threshold to reduce an effect of the periodic component.

8. The method of claim 1, wherein the interaction time-series data includes an edit to a business website and a user search for the business, and
wherein the edit to the business website is weighted more heavily than the user search for the business in the interaction time-series data when determining the rate of user interactions.

9. The method of claim 1, wherein different types of interactions in the interaction time-series data are weighted differently when determining the rate of user interactions.

10. The method of claim 9, wherein the weightings for the different types of interactions are adjusted based on user feedback indicative of false positives or false negatives in the identification of closed businesses.

11. The method of claim 1, wherein the time that has passed without receiving the requested confirmation is selected based on a way in which the message is conveyed.

12. The method of claim 1, wherein the time that has passed without receiving the requested confirmation is selected based on a category of the business.

13. The method of claim 1, wherein the user interaction time-series data includes timestamps indicative of when a user checked into the business, when a user posted a review of the business, when a user searched a web search engine for information related to the business, or when a website of the business was edited.

14. The method of claim 1, wherein transmitting the message requesting confirmation that the business is still open comprises sending a postcard to the business, sending an email to the business, making a phone call to the business, or sending a text message to the business.

15. The method of claim 1, wherein detecting a decrease in the rate of user interactions with the data about the business based on baseline rate and the interaction time-series data comprises:
comparing the rate of user interactions to a threshold, wherein the threshold is based on the baseline rate and adjusted based on a variability in the baseline rate of user interactions.

16. The method of claim 1, wherein detecting a decrease in the rate of user interactions with the data about the business based on baseline rate and the interaction time-series data comprises:
comparing the rate of user interactions to a threshold, wherein the threshold is based on the baseline rate and adjusted based on a sample size of the rate of user interactions.

17. The method of claim 1, wherein detecting a decrease in the rate of user interactions with the data about the business based on baseline rate and the interaction time-series data comprises:
determining a threshold as a proportion of the baseline rate; and
determining that a moving average of the time-series data has crossed the threshold.

18. A system, comprising:
one or more processors; and
memory storing instructions that when executed by the one or more processors cause the processors to effectuate operations comprising:
obtaining interaction time-series data identifying when users interacted with data about a business;
calculating a baseline rate of user interactions with the data about the businesses based on the interaction time-series data;
detecting a decrease in the rate of user interactions with the data about the business based on the baseline rate and the interaction time-series data;
transmitting a message to the business requesting confirmation that the business is still open;
detecting that a time has passed without receiving the requested confirmation; and
removing the business from a business listing or otherwise indicating in the listing that the business is closed.

19. A tangible, non-transitory, machine-readable medium storing instructions that when executed by a data processing apparatus cause the data processing apparatus to perform operations comprising:
obtaining interaction time-series data identifying when users interacted with data about a business;
calculating a baseline rate of user interactions with the data about the businesses based on the interaction time-series data;
detecting, with a computer, a decrease in the rate of user interactions with the data about the business based on the baseline rate and the interaction time-series data;
transmitting a message to the business requesting confirmation that the business is still open;
detecting that a time has passed without receiving the requested confirmation; and
removing the business from a business listing or otherwise indicating in the listing that the business is closed.
